(19) United States
(12) Patent Application Publication
(10) Pub. No.: US 2008/0221736 A1
(43) Pub. Date: Sep. 11, 2008

(54) UNIT FOR SUPERVISING AND REPORTING THE OPERATING STATUS OF A PORTABLE TOOL FOR MACHINING SURFACES

(76) Inventor: Guido Valentini, Milano (IT)

Correspondence Address: MICHAEL BEST & FRIEDRICH LLP, 100 E WISCONSIN AVENUE, Suite 3300, MILWAUKEE, WI, 53202, US

(21) Appl. No.: 12/038,565

(22) Filed: Feb. 27, 2008

(30) Foreign Application Priority Data
Mar. 5, 2007 (IT) MI2007A000466

(51) Int. Cl. G05B 15/00

(52) U.S. Cl. 700/275

(57) ABSTRACT

A portable electric or pneumatic tool for machining surfaces is provided with a unit (6) for supervising and reporting the operating status of the tool (1) comprises a detecting unit (12) operationally connected to a driving member (4) of the tool to detect if the tool is operating, a pulse emitting clock (16), a counter (14) enabled by said detecting unit for counting said pulses, a non-volatile memory (15) operationally connected to said counter (14), a detecting device (17) for detecting the count status that is operationally connected to said counter (14) for detecting the reaching of set count status indicating a preset number of working hours of the tool and means (18, 5) for displaying and reporting the reaching of said count status. The unit (6) for supervising and reporting is preferably supplied by a battery (9), independently of the electric or pneumatic supply (8) to the tool (1) (FIG. 4).

The present invention relates to a unit for supervising and reporting the operating status of a portable tool for machining surfaces.

Portable tools for machining surfaces are known that are driven electrically or by compressed air.

The aforesaid tools require maintenance operations the frequency of which cannot be foreseen “a priori” because it depends on the degree of wear to the tool, which in turn depends on the number of hours of operation of the tool.

It would also be desirable to be able to have at a distance the data on the hours of operation of the tool so as to be able to manage the maintenance of a series of tools through a single central unit.

A first object of the present invention is thus to make a unit for supervising and reporting the operating status of a portable tool for machining surfaces that enables precise indications to be obtained on the hours of operation of the tool and on basis of such information provides an indication of the urgency of maintenance.

A second object is to make a unit for supervising and reporting that enables the data relating to a tool to be supplied to an external central unit in order to enable the latter to manage simultaneously the operating conditions of several tools.

In accordance with the aforesaid objects the present invention provides a unit for supervising and reporting, that is characterised in that it comprises a detecting unit operationally connected to a driving member of the tool to detect if the tool is operating, a pulse emitting clock, a counter enabled by said detecting unit for counting said pulses, a non-volatile memory operationally connected to said counter, a detecting device for detecting the count status that is operationally connected to said counter for detecting the reaching of a preset count status indicating a preset number of working hours of the tool and means for displaying and reporting the reaching of said count status.

Preferably, the unit for supervising and reporting is provided with an autonomous electric power supply, in particular a battery supply.

It is further preferably provided that said unit for supervising and reporting is provided with an interface device, such as, for example, an optical infrared port or a WI-FI device, that enables the detected information to be accessed externally and dialogues with the control unit to be possibly conducted.

The features of the present invention will become clear from the following detailed description of a practical embodiment thereof illustrated by way of non-limiting example in the attached drawings, in which:

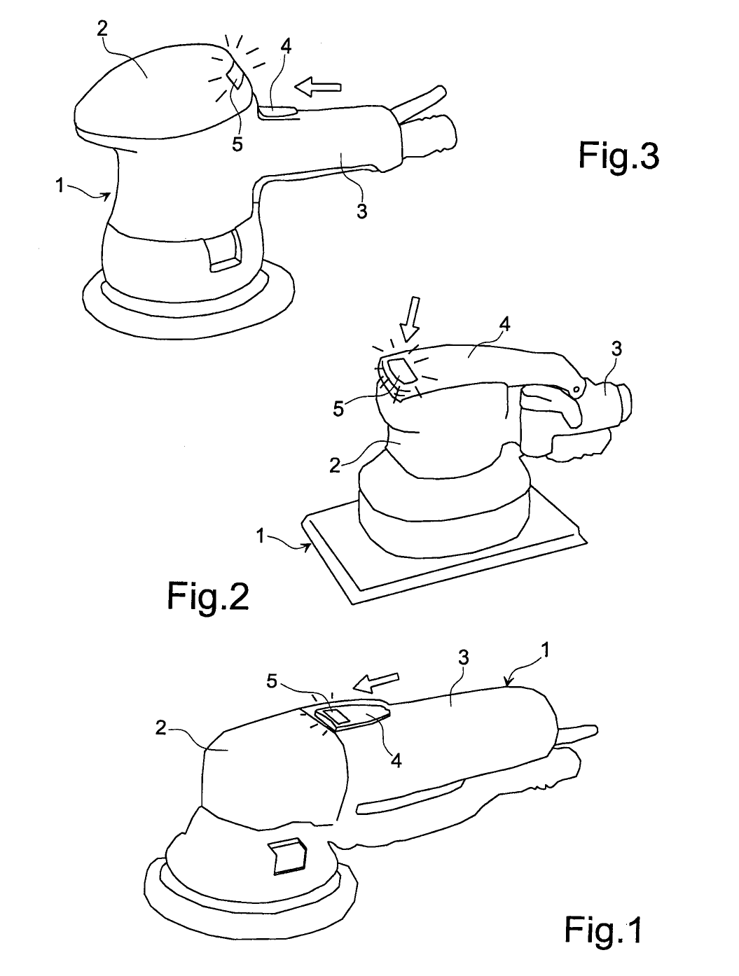

FIG. 1 shows schematically a first example of a portable tool provided with a unit for supervising and reporting according to the present invention;

FIG. 2 shows schematically a second example of a portable tool provided with a unit for supervising and reporting according to the present invention;

FIG. 3 shows schematically a third example of a portable tool provided with a unit for supervising and reporting according to the present invention;

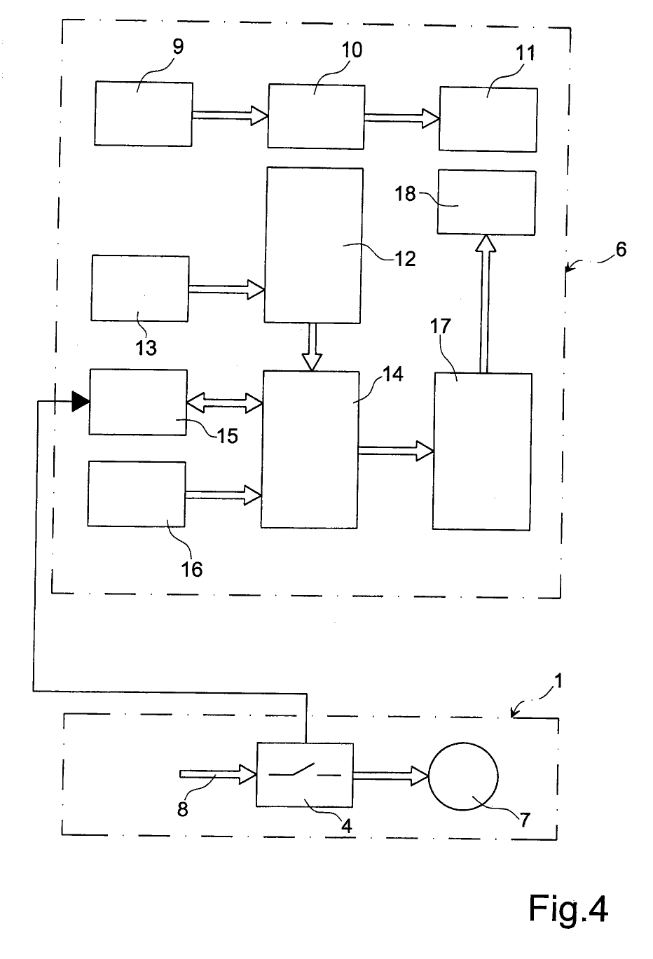

FIG. 4 shows a block diagram of said unit for supervising and reporting.

In FIG. 1 there is shown schematically, merely by way of example, a portable tool for machining surfaces, which is indicated overall with the reference number 1 and comprises a head 2 with a grip 3.

On the grip 3 there is provided a driving member 4 of the key type that includes an optical viewer 5.

In FIG. 2 there is schematically shown a version with a driving member 4 of the lever type that extends on the head 2 and also has an optical viewer 5.

In FIG. 3 there is lastly illustrated a further version with a key driving member 4 positioned on the grip 3 and an optical viewer 5 positioned on the head 2.

Inside the tool there is arranged a unit for supervising and reporting that has the task of detecting and indicating that a determined number of tool operating hours has been reached.

A block diagram of the aforesaid unit for supervising and reporting is shown and indicated overall by 6 in FIG. 4, where the basic block diagram of the tool 1 is also shown, essentially comprising an electric or pneumatic motor 7 and the driving member 4 (indicated as an electric or pneumatic switch inserted into an independent electric or pneumatic supply 8).

As shown in FIG. 4, the unit for supervising and reporting 6 comprises firstly a supply part consisting of an electric battery 9 and a DC/DC converter 10 that provides a stabilised direct-current supply to an electronic card 11 that supplies the unit for supervising and reporting.

Alternatively, instead of the battery 6, in the case of an electric tool, it is possible to use the mains electric power supply.

The unit 6 also comprises a detecting unit for detecting the tool in operation, indicated by 12, that uses a digital input 13 to detect if the driving member 4 is in connected or disconnected state, i.e. whether it is switched ON or OFF. The digital input 13 can be provided, for example, by a vibrations sensor.

The detecting unit 12 is suitable for enabling a counter 14 provided with a non-volatile memory 15 that, when it is enabled following the detection of the operating tool, counts the pulses emitted by a clock 16.

A count status detecting device, indicated by 17, detects the reaching of a preset number of pulses, corresponding to a set number of operating hours of the tool, and supplies corresponding information to display and reporting means 18, such as, for example, the viewer 5 in FIGS. 1-3.

If desired, the detecting device 17 can also send information to a WI-FI device or to an infrared optical port, or, in general, to an interface device that enables the detected information to be accessed remotely and dialogues with a central control unit for several tools to be conducted.

The unit 12 for detecting tools in operation, the counter 14, the memory 15, the clock 16, the detecting device 17 and the converter 10 are preferably provided inside a single microprocessor.

Substantially, with the driving member 4 in the OFF position the tool is switched off and the unit for supervising and reporting 6 is at rest.

If the driving member 4 is in the ON position, the digital input 13 reports to the detecting unit 12 that the tool is operating, so the unit 12 enables the pulse count of the clock 16 by the counter 14.

When the number of pulses counted reaches a set value which is indicative of a corresponding number of operating hours of the tool, and therefore of likely wear to the tool, the detecting device 17 supplies the corresponding information to the display and reporting means 18, which in turn informs the operator.

It should be noted that if the battery 9 becomes exhausted, the tool would continue to operate because the supply 8 to the tool is independent from the battery 9.

When the driving member 4 is returned to the OFF position, the tool stops working and everything returns to the rest position.

1-5. (canceled)

6. A unit for supervising and reporting an operating status of a portable tool for machining surfaces, characterized in that the unit comprises a detecting unit operationally connected to a driving member of the portable tool to detect if the portable tool is operating; a pulse emitting clock; a counter enabled by the detecting unit for counting pulses from the pulse emitting clock; a non-volatile memory operationally connected to the counter; a detecting device for detecting a count status, the detecting device being operationally connected to the counter for detecting reaching of a preset count status indicating a set number of working hours of the portable tool; and a display device that displays the reaching of the preset count status.

7. The unit for supervising and reporting according to claim 6, characterized in that the unit comprises a supply battery that is independent from at least one of an electric supply and a pneumatic supply.

8. The unit for supervising and reporting according to claim 6, characterized in that the display device includes a viewer placed on a body of the portable tool.

9. The unit for supervising and reporting according to claim 7, characterized in that the display device includes a viewer placed on a body of the tool.

10. The unit for supervising and reporting according to claim 6, characterized in that the detecting unit is operationally connected to the driving member by a digital input.

11. The unit for supervising and reporting according to claim 7, characterized in that the detecting unit is operationally connected to the driving member by a digital input.

12. The unit for supervising and reporting according to claim 8, characterized in that the detecting unit is operationally connected to the driving member by a digital input.

13. The unit for supervising and reporting according to claim 9, characterized in that the detecting unit is operationally connected to the driving member by a digital input.

14. The unit for supervising and reporting according to claim 10, characterized in that the digital input is supplied by a vibrations sensor.

15. The unit for supervising and reporting according to claim 11, characterized in that the digital input is supplied by a vibrations sensor.

16. The unit for supervising and reporting according to claim 12, characterized in that the digital input is supplied by a vibrations sensor.

17. The unit for supervising and reporting according to claim 13, characterized in that the digital input is supplied by a vibrations sensor.
